(19) United States
(12) Patent Application Publication
(10) Pub. No.: US 2013/0339122 A1
(43) Pub. Date: Dec. 19, 2013

(54) METHOD AND APPARATUS FOR PROVIDING AN INTEGRATED SHOPPING EXPERIENCE

(71) Applicant: SCANSEE, INC., Dallas, TX (US)

(72) Inventors: Roy Truitt, Dallas, TX (US); Nate Ungarean, Dallas, TX (US)

(73) Assignee: ScanSee, Inc., Dallas, TX (US)

(21) Appl. No.: 13/757,181

(22) Filed: Feb. 1, 2013

Related U.S. Application Data
(60) Provisional application No. 61/660,070, filed on Jun. 15, 2012.

(51) Int. Cl. G06Q 30/02

(52) U.S. Cl. CPC G06Q 30/0269
USPC 705/14.26; 705/14.66; 705/14.58; 705/14.57; 705/14.45; 705/14.64

(57) ABSTRACT

Systems and methods for facilitating retail inventory management, marketing, shopping, research, and data gathering operations via a unified application framework are described. These systems may provide an integrated shopping experience such that users are exposed to relevant product information, promotion information, and merchant information through a single application and via a unified framework. A customer device as described may be configured to interface over a network with one or more network devices to access information on retailers, product offerings, coupons, rebates, loyalty rewards, other purchase incentives, and/or the like. Some examples further include a back office interface accessible by suppliers, retailers, manufacturers and/or the like. The back office interface may enable suppliers, retailers, manufacturers, and/or other parties to upload content, such as, product information, advertisements, coupons, rebates, and/or the like, such that the uploaded content may be accessible by users of the mobile application provided by some example embodiments.

### CROSS-REFERENCE TO RELATED APPLICATIONS

This application claims the benefit of U.S. Provisional Application No. 61/660,070, filed Jun. 15, 2012, and herein incorporated by reference in its entirety.

### TECHNOLOGICAL FIELD

Example embodiments of the present invention relate generally to computer-provided services and, more particularly, relate to systems, methods, apparatuses, and computer program products for providing an interactive shopping application.

### BACKGROUND

Advances in miniaturization and network technology have granted an unprecedented level of access to data and processing power on today's mobile devices. Smart phones, tablets, and the like are able to access data via global data networks from all but the remotest locations. Ubiquitous access to the Internet has also led to an explosion in the volume of business conducted online. Even companies that primarily do business via brick-and-mortar stores maintain a robust Internet presence to market their products and educate their customers. So too have product manufacturers and suppliers increased their web presence by offering product information, technical support, and customer service via web portals. When a customer wishes to buy a product, it is typical for them to visit several different sites before making a purchase. The customer may first research the product itself to ensure it meets their needs, then decide upon a retailer by comparison price shopping, determining whether a retailer has a nearby location or shipping availability, and determining whether the item is in stock. To facilitate this process, the customer may need to access a manufacturer website, a retailer website, and one or more “deal” websites to identify appropriate coupons and/or rebate options for the product.

In order to make a completely informed purchase, the onus is on the customer to perform each of the steps of the enumerated process. Even where price aggregation websites compare prices from numerous retailers, the customer must still take the time to identify the product, determine stock levels, and seek out appropriate deals to optimize their purchase. Smaller retailers or other retailers that are not examined by price comparison websites may be missed and customers may act without having full information. Retailers may be inclined to offer deals on products at particular locations based on inventory levels (e.g., overstocked products), but they may be reluctant to offer deals to all customers at once due to worries that deals will be overused. Users may be unaware of alternative products that would also satisfy their needs. As such, the current state of the art provides an inefficient, inadequate solution for shopping in an increasingly interconnected, networked world.

In the context of a user shopping experience, if a customer wishes to perform product price comparisons, search for optimal deals, and identify promotions for the particular product for which they are searching, the customer must search multiple locations and interact with several different entities. After aggregating data across these disparate sources, the customer must then parse, analyze, and cross reference the data to reach a conclusion about what to purchase and where and how to purchase it. Although the content may be available to the user, the user must actively seek and process the information to arrive at the optimal shopping experience. The time and effort required to perform this analysis results in many users failing to thoroughly research their purchases, resulting in sub-optimal purchase decisions.

Similarly, merchants and suppliers are not exposed to interested customers in an efficient manner; blanket advertising and promotional methods may be clumsily targeted such that they miss interested customers and bother customers who are not interested in the particular product or service.

### SUMMARY

Some example embodiments provide systems and methods for facilitating retail inventory management, marketing, shopping, research, and data gathering operations via a unified application framework. These embodiments may provide an integrated shopping experience such that users are exposed to relevant product information, promotion information, and merchant information through a single application and via a unified framework. Example embodiments may be implemented on one or more computing devices, including mobile terminals, such as smart phones, tablets, and the like, and one or more data servers. A customer device as described in some example embodiments may be configured to interface over a network with one or more network devices to access information on retailers, product offerings, coupons, rebates, loyalty rewards, other purchase incentives, and/or the like. Some example embodiments further a back office interface accessible by suppliers, retailers, and/or the like. The back office interface may enable suppliers, retailers, and/or other parties to upload content, such as, product information, advertisements, coupons, rebates, and/or the like, such that the uploaded content may be accessible by users of the mobile application provided by some example embodiments. The back office interface provided by some example embodiments further enables suppliers, retailers, and/or other parties to access sales information, consumer demographics, inventory data, and/or other data that may be tracked in accordance with various example embodiments.

This mobile application and supporting back office interface provided by some example embodiments make shopping easy for consumers. In this regard, the mobile application of some example embodiments helps the user create and maintain shopping lists, view nearby retailers and their products, the sales and deals details, retrieve product details by scanning their bar codes and also search for product details over 3^{rd} party APIs. The mobile application of some example embodiments further provides seamless integration with live data that may be tracked by the system of some example embodiments and/or that may be uploaded to the system of some example embodiments via the back office interface. The mobile application of some example embodiments may additionally be configured to provide channels to claim offers. Further, the mobile application of some example embodiments may be configured to integrate with one or more social networks to enable a user to share product and offer details via email and/or social network distribution.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 depicts a block diagram of an apparatus in accordance with some example embodiments;

FIG. 2 depicts a block diagram of a system for providing an integrated shopping experience in accordance with some example embodiments;

FIG. 3 depicts a display for scanning an item identifier in accordance with some example embodiments;

FIG. 4 depicts a flow diagram of a method for receiving item information in accordance with some example embodiments;

FIG. 5 depicts a flow diagram of a method for identifying and transmitting item information in accordance with some example embodiments;

FIG. 6 depicts a flow diagram of a method for receiving shopping information based on a location in accordance with some example embodiments;

FIG. 7 depicts a flow diagram of a method for providing location-based shopping information in accordance with some example embodiments;

FIG. 8 depicts a flow diagram of a method for capturing user shopping information in accordance with some example embodiments;

FIG. 9 depicts a screen capture of an interface for allowing a supplier or merchant to interface with the system in accordance with some example embodiments;

FIG. 10 depicts an interface for generating deal information in accordance with some example embodiments;

FIG. 11 depicts a screen capture of an interface for generating rebate information in accordance with some example embodiments;

FIG. 12 depicts a screen capture of an interface for generating a coupon in accordance with some example embodiments;

FIG. 13 depicts a flow diagram of a method for providing promotions to customers in accordance with some example embodiments; and

FIG. 14 depicts a flow diagram for providing data requests to customers in accordance with some example embodiments.

### DETAILED DESCRIPTION

Aspects of the disclosure include an integrated system for providing an integrated shopping system that allows for users to be provided with relevant, topical, useful information about products and services while also allowing efficient marketing, promotion, and inventory management by merchants and suppliers. Example embodiments include methods, systems, apparatuses, and computer program products for leveraging ubiquitous mobile Internet access to assist users with product and merchant selection, including providing product information, inventory information, and promotion information to customers. The system may provide a real-time platform for suppliers, retailers, and customers to save time and money by improving the overall efficiency of the shopping and marketing process.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

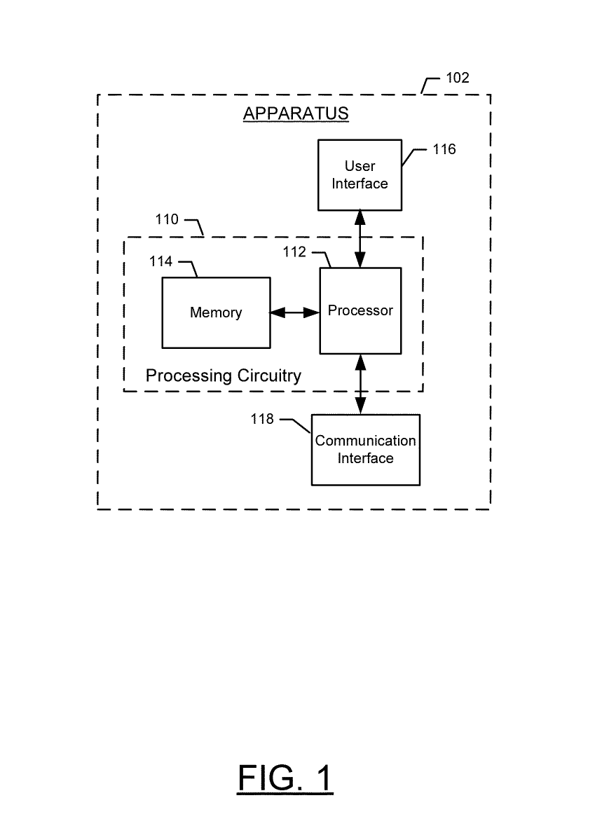

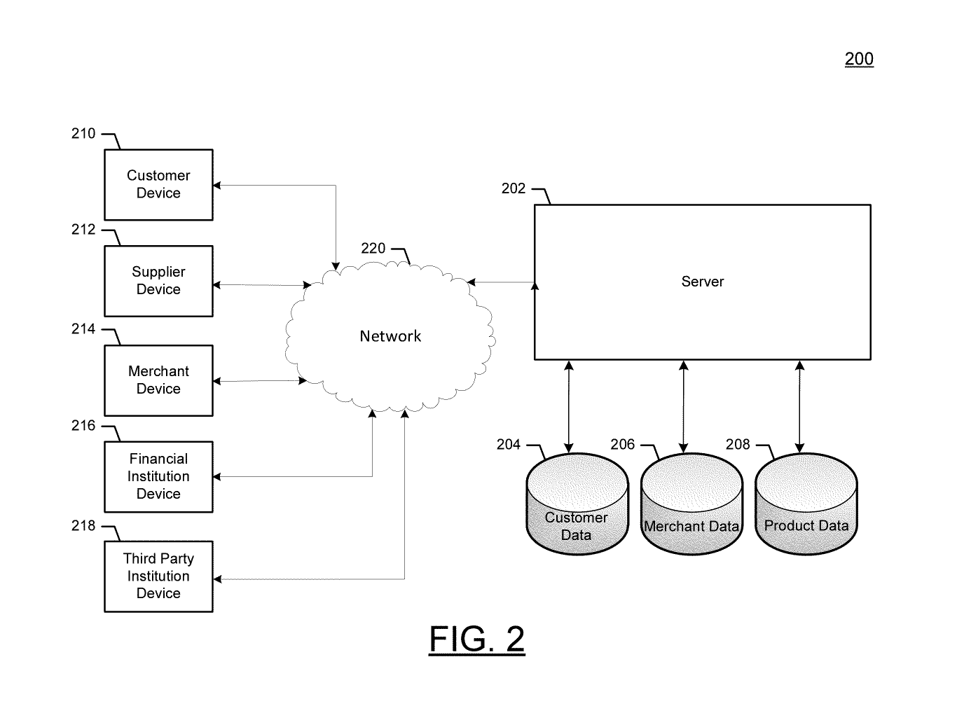

FIG. 1 illustrates a block diagram of an apparatus 102 in accordance with some example embodiments. For example, the apparatus 102 may be implemented on a mobile computing device that may be configured implement and control a mobile application in accordance with various example embodiments. As another example, the apparatus 102 may be implemented on one or more servers to provide a back office interface and/or web interface in accordance with various example embodiments. Examples of computing devices that may correspond to the apparatus 102 are described further below with respect to FIG. 2. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface) 18 via a bus(es) for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms. In embodiments in which the apparatus 102 is implemented on a server, aspects of the user interface 116 may be limited, or the user interface 116 may even be eliminated.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

FIG. 2 depicts a block diagram of a system 200 for providing an integrated shopping experience in accordance with some example embodiments. The system 200 may include several computing nodes or devices in communication with one another. Each of the devices may have the same or similar configuration to the apparatus 102 described with respect to FIG. 1. The system 200 may include a server 202 in communication with one or more of a customer device 210, a supplier device 212, a merchant device 214, a financial institution device 216, and/or a third party device 218. The server 202 may send and receive data to and from these devices 210-218 to facilitate an integrated shopping experience.

The server 202 may access one or more datastores. These datastores may include a customer datastore 204, a merchant datastore 206, and a product datastore 208. By accessing these datastores, the server 202 may provide targeted promotions and product data to customers to improve the customer's shopping experience.

The customer datastore 204 may include details for particular customers or users of the system. The customer datastore 204 may store access credential information (e.g., usernames, passwords, encryption tokens, or the like) to allow customers a secure operating environment to access data provided by the server 202. The customer datastore 204 may further include session information and other information related to e-commerce transactions. For example, the customer datastore 204 may include a customer's product view history, a listing of items scanned by the customer, one or more shopping lists generated by the customer, or the like. When the customer logs in to the system 202, they may be presented with information associated with previous sessions, such as the aforementioned history, recent transactions, recent scans, or the like. The customer datastore 204 may further include customer demographic information, such as the age, gender, city of residence, or the like. Such customer demographic information may be used to provide the customer with promotions that are particularly relevant to the customer. Customer data may be captured via a voluntary or “opt in” process such that customers do not have to provide demographic data to use the system. In such circumstances, certain features of the system 200 that rely on the use of demographic information may be disabled. In some aspects, customer demographic information may be processed in aggregate and analyzed. The system 200 employs privacy protections to ensure that private customer data is not exposed, although aggregate customer data may be provided to one or more merchants or suppliers for planning purposes. Information that identifies particular customers may be anonymized during the aggregation process such that no customer's private data is exposed outside of the system 200.

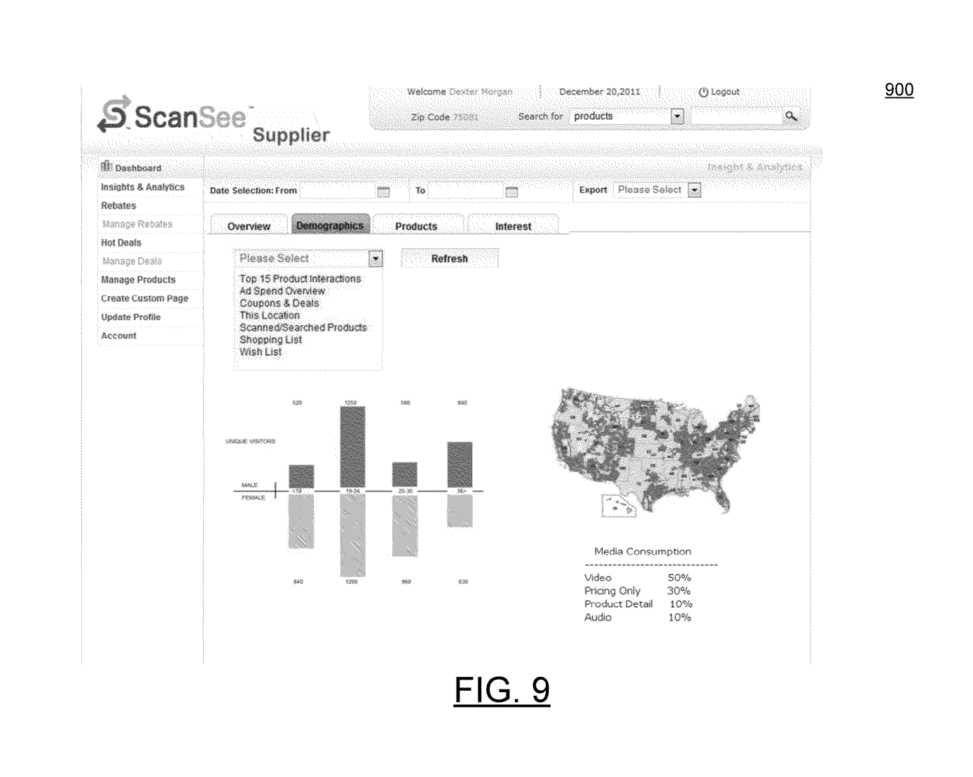

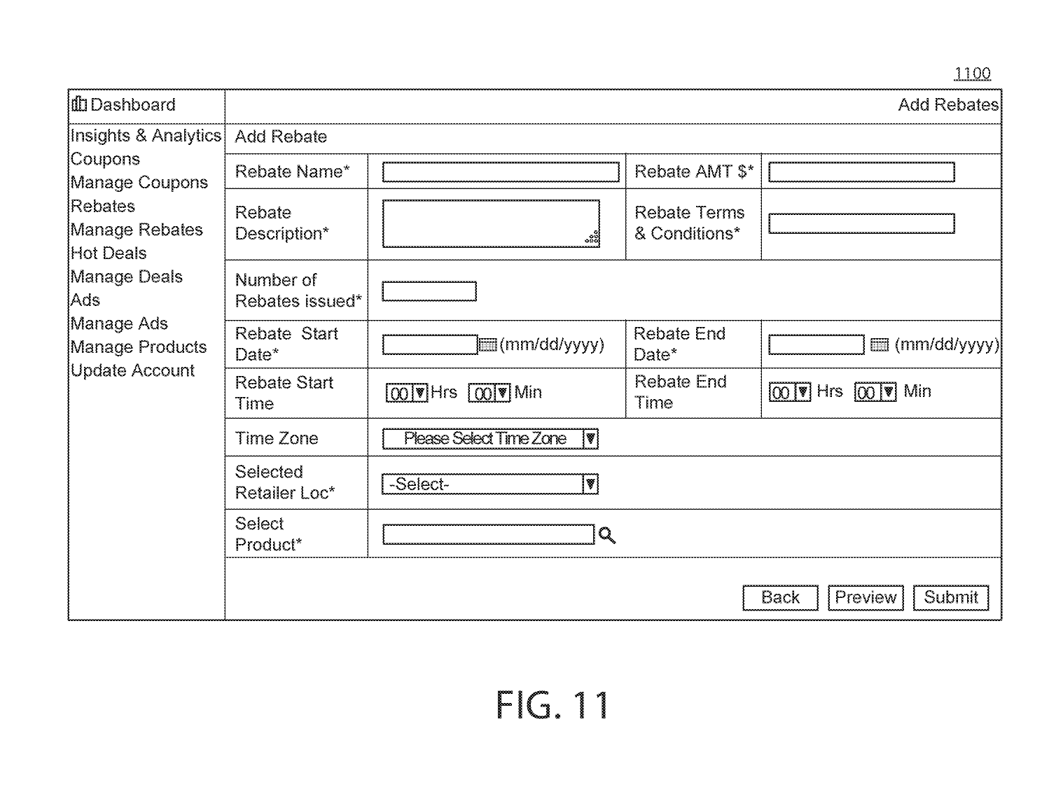

The merchant datastore 206 may include information pertaining to particular retailers, store locations, e-commerce sites, or the like. This information may include product store location data (e.g., store addresses, phone numbers, and hours), inventory levels, marketing information, product promotions, or the like. The merchant datastore 206 may reflect updates manually added by merchants, such as by the merchant device 214 through an interface provided by the server 202 (see, e.g., FIGS. 9-11), or the merchant datastore 206 may be populated via access to a merchant system. For example, the server 202 may expose an application programming interface (API) to a merchant database or system to allow the merchant to automatically update the merchant datastore 206 with, for example, product inventory levels. The merchant datastore 206 may also include promotions for particular items or particular locations. The promotions may be linked to a particular items or products stored in the product datastore 208. In some embodiments, promotions may be associated with specific criteria. For example, a promotion may be for a product discount (e.g., 10% off, 25% off, buy one get one free, or the like) for a particular product at a particular location.

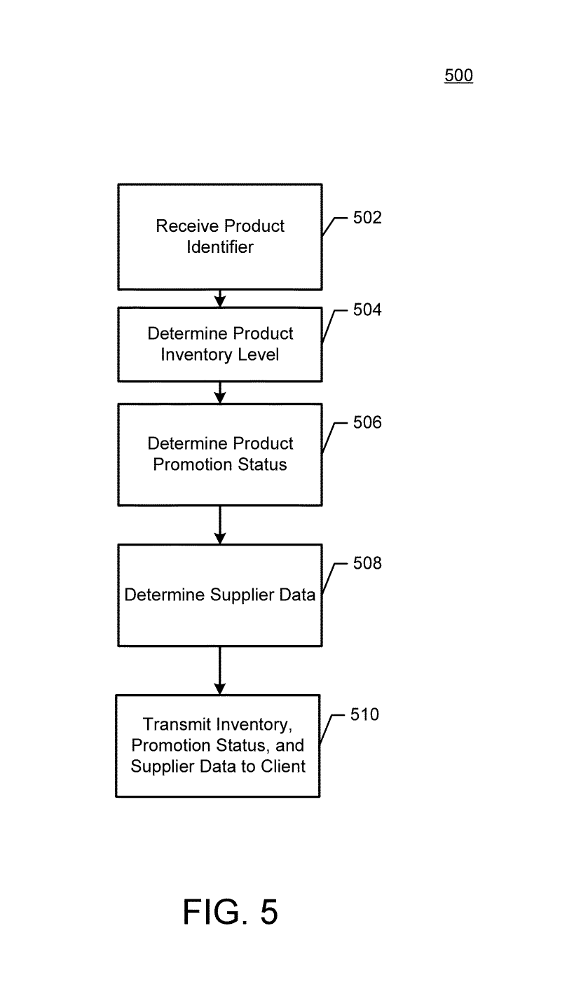

The merchant datastore 206 may include marketing information related to products, promotions, or locations. For example, the merchant may mark a particular promotion as being relevant to customers within a particular radius (e.g., 1 mile, 5 miles, 10 miles) of a particular store location, to customers in a particular age group (e.g., 18 to 25 years old), or a particular gender. Customer data stored in the customer datastore 204 may also be referenced to provide promotion information, such as by notifying customers that previously expressed an interest in the promoted product that a discount is available. Examples of processes for providing promotion information to customers is described further below with respect to FIGS. 5-8. Customers that meet the criteria for the promotion may be notified of the promotion.

The product datastore 208 may include information relating to particular products or services. For example, each product in the product datastore 208 may be associated with a product identifier, such as a Universal Product Code (UPC) barcode, a radio frequency identification (RFID) tag, or a quick recognition (QR) code. Manufacturers of the product may be provided with permissions to access and edit the product datastore 208 to add information relating to the products. For example, a supplier may include a reference to an informational website for the product, locations of retailers where the product may be purchased, or the like. In this manner, the supplier may assist users with learning more about their product or service by including data in a central repository that is easily accessible by a customer accessing the system 200. The supplier may also include rebate information or other promotional information as associated with the particular product in a similar manner to how the merchant may provide promotions.

In some embodiments, the manufacturer or retailer may also configure a website or other application associated with their product or location, such that when a user scans the product or enters the location, the user is presented with the website or the application is executed. For example, a manufacturer or retailer may create a site for their product or location that includes informational items, links to external sites, custom pages hosted by the system 100, special offers/sales, or the like. The retailer or manufacturer may be presented with an interface to log into the system to build these pages. These pages may function to provide “app-like” functionality to the retailer or manufacturer without the need to create a separate application to execute on the user's device. When the page is created, the page owner may receive a QR code or another physical token that links to the page within the application executing on the user's device. The retailer or manufacturer may distribute this physical token at their storefront, in the marketing materials, or affixed to their products or packaging. When the physical token is scanned by the user application the system may recognize the scan and send the consumer to the retailer's or manufacturer's main app site within the system. If the physical token is scanned with another scanner/program, a website associated with the product may display within a web brower, and the consumer may be presented with an option to download a scanning application designed to interface with the system 200. Thus, the physical token may have dual functionality, where a first action is taken if the physical token is scanned within the application designed to interface with the system 200 (e.g., navigating to the product or location information within the system 200), and a second action is taken if the physical token is scanned by another application (e.g., navigating to a web page relating to the product or retailer that is hosted by the system 200, but that does not require the application associated with the system 200 to execute).

As described above, the server 202 may be configured to interface with a variety of computing devices located at the same or different nodes of the network 202. The customer device 210 may include a mobile terminal executing a client application or “app” to provide the user with mobile access to an integrated shopping experience. For example, the customer device 210 may include a smart phone, a cellular phone, a tablet computer, a laptop, or the like. Although the customer device 210 may be generally described with respect to a mobile terminal, the customer device 210 may also be a desktop or other stationary computing device. The customer device 210 may allow for the user to identify products in a shopping environment and receive data about those products from the server 202.

The customer device 210 may be operable to determine a location and transmit the location to the server 202 for the purpose of receiving targeted promotions or shopping information based on the determined location. For example, a user may wish to learn more about a product that they encounter at their local department store. The user may use a barcode scanner or other input device coupled to the customer device 210 to identify a product identifier the product about which the user wishes to learn more. The customer device 210 may transmit the product identifier to the server 202 and, in response, receive information relating to the product. The customer device 210 may further identify a location of the user to the server 202. For example, the customer device 210 may receive location information from a sensor, such as a global positioning system (GPS) receiver coupled to the user device, or the customer device may prompt the user for an address or zip code. In some embodiments, the user is prompted before transmitting the location to the server 202 to allow the user to prevent transmission of their location information.

In response to receiving location information from the customer device 210, the server 202 may identify nearby merchants that sell the product in question. The server 202 may further identify whether any merchants proximate to the user are offering a promotion for the item in question, and notify the user in the event any such promotions exist. The server 202 may further identify one or more e-commerce merchants to the user to allow the user to comparison shop between online merchants and brick-and-mortar stores. The server 202 may further identify stock levels of the product at different merchants in the area. The server 202 may also provide product information provided by a supplier of the product. For example, a manufacturer may upload product specifications, images, or customer support contact information to the product datastore 208 and the server 202 may provide such data in response to receiving a product identifier.

In some embodiments, the customer device 210 may indicate a location to the server 202 without a particular product identifier, and the customer device 210 may be provided with a list of ongoing promotions proximate to the customer device 210. In this manner, the user may shop for deals without having a particular product or service in mind. In some embodiments, the location identifies a particular store or merchant at which the user is present, such that the user may be able to search for deals based on a particular merchant, rather than from all merchants within the particular proximity range to the user.

The server 202 may be further configured to communicate with a supplier device 212. The supplier device 212 may be a computing device as known in the art, such as the apparatus 102 described with respect to FIG. 1. The server 202 may include a “back office” interface for product supplier or manufacturers to supply information about their products. For example, the server 202 may include a web page interface allowing manufacturers to log in and update information about products they provide, such as technical specifications, suggested retail prices, images, instructional videos, and the like. The server 202 may provide for authentication and verification of suppliers prior to allowing edits to the product datastore 208. In this manner, suppliers may add and edit product information to the product datastore 208 to efficiently inform customers of the features and benefits their products provide.

The server 202 may also communicate with a merchant device 214. The merchant device 214 may allow the merchant to provide data to the server 202 such that the system 200 may provide a user with merchant information, such as store inventory data, store location data, and product promotion data. As described above with respect to the supplier device 212, the server 202 may provide an interface allowing the merchant to add or edit information stored within the merchant datastore 206. The merchant device 214 may be a computing device or devices, such as the apparatus 102, that may interact with the server 202 over the network, such as by a web interface or an API.

The server 202 may also communicate with a financial institution device 216. As described above with respect to the merchant device 214 and the supplier device 212, the financial institution device 216 may be a computing device such as the apparatus 102. In some embodiments, the financial institution device 216 may provide an interface with a financial network, such as a credit card provider or automated clearing house (ACH) service. The financial institution device 216 may be operable to provide the server 202 with the ability to perform and verify financial transactions. For example, the financial institution device 216 may be operable to compensate users of the system 200 in response to completion of data gathering assignments proposed by one or more suppliers or merchants, or the system may allow for payment systems that allow users to order products directly from a source, such as an online retailer, local retailer, directly from the manufacturer, or the like.

In some embodiments, the third party institution 218 may include one or more data sources other than the merchants and suppliers, such as applications that aggregate and provide market data. For example, the server 202 may interface with third party APIs to populate the product datastore 208 with technical data or information in the event product suppliers do not populate the data themselves. Alternately, the server 202 may access data feeds about products that do not directly correspond to supplier or merchant data, such as user reviews of the product.

The network 220 may allow communication among the server 202 and the various devices 210-210. The network 220 may be implemented as any communication media, including wireless and/or wireline communications such as Ethernet, 802.11, and the like. Although the devices disclosed herein are represented as separate blocks, these devices could also include multiple computing devices, or multiple blocks could reside in a single computing device. The network 220 may be a packet switched network, such as the Internet.

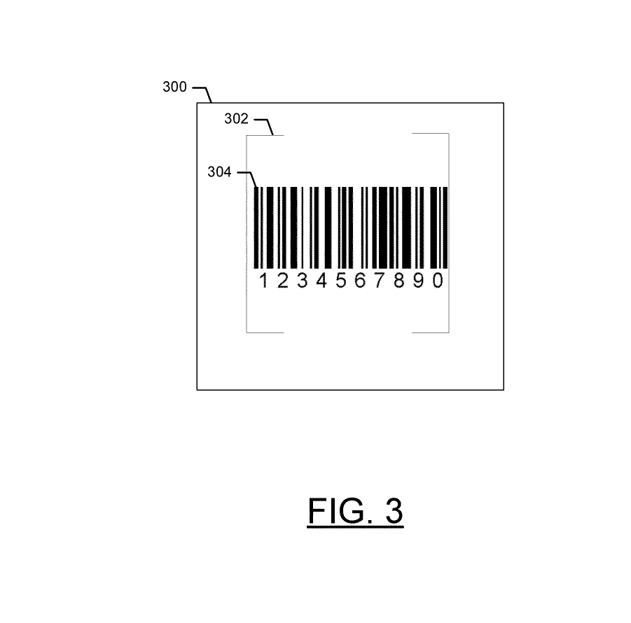

FIG. 3 depicts a display 300 for scanning an item identifier in accordance with some example embodiments. The display 300 may represent a visual display on a mobile terminal, such as the customer device 210 or the apparatus 102. The display 300 may include a visual indicator to assist the user with capturing a product identifier, such as a set of brackets 302 used to line up a bar code 304 for recognition by the mobile terminal. The mobile terminal 304 may automatically capture the identifier when the identifier is properly displayed in the display 300. Although the present example describes use with a bar code, such as a UPC, the same or similar techniques could also be applied to QR codes or other methods of obtaining product identifiers. For example, the mobile terminal might receive a product identifier via Near Field Communications (NFC) or RFID communications with a tag included in product packaging. Upon determination of the product identifier, the mobile terminal may transmit the identifier to a server, such as the server 202, to receive information, promotions, and the like relating to the product.

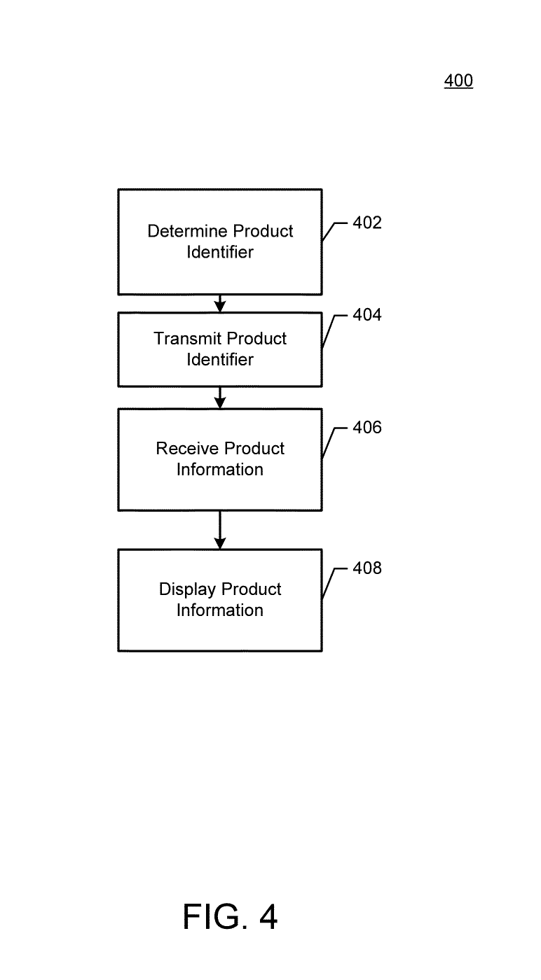

FIG. 4 depicts a flow diagram of a method 400 for receiving product information in accordance with some example embodiments. The method 400 is operable to provide a user with information about a product or service based on determining an identifier associated with the product or service. For example, a user may utilize a bar code scanner, device camera, or RFID reader coupled to a mobile device to obtain a UPC code or other product identifier from packaging associated with a product or service. The product identifier may be used to obtain information about the product, such as product technical specifications, prices, promotions, and the like.

At action 402, a product identifier is determined. For example, as described above, the user may capture a product identifier using a sensor coupled to a mobile terminal. Alternately or additionally, the user may also search for an item based on an item name, model number, or the like. In response to the search, the user may be presented with a list of one or more items corresponding with the search criteria, and the user may select a product from the list. Each of the products within the list may also be associated with a product identifier, and in this manner the user may provide a product identifier without having to determine the identifier from the product itself In some embodiments, the ability to search for a product may be provided via a “Find” application. The find application may allow for users to conduct a keyword search in addition to direct searches of product names or identifiers. For example, a retailer or supplier may be provided with an interface to select particular keywords for association with a product they provide, such that when a user searches for the particular keyword, they are provided with a link to the product. Additionally or alternatively, keywords may be associated with locations, corporations (e.g., the retailer or a product manufacturer), such that when a user searches for a particular keyword, they may be provided with relevant locations, manufacturers, or the like in their search results. The application may further allow for various types of searches, such as selecting the type of search results (e.g., locations as search results instead of products), or searching based on certain sub-categories (e.g., searching for a particular type of location selected from a list).

If the product identifier is captured via a device sensor, the sensor may be activated in response to the user providing an indication that they wish to begin an identification operation. For example, the device camera may be activated to scan the barcode of the product and barcode types (e.g., standard UPC, QR code, etc.) may be displayed on a display of the mobile device. In some aspects, product packing may include a label with a unique identifier for use only with a system, such as the system 200, and separate and distinct from a product UPC code. Additional interface options may also be provided such as tool bars enabling searching of products or a historical list of previously accessed products. The interface may also allow for modification of image capture operations, such as enabling a light or flash for a camera used to capture a bar code image.

At action 404, the product identifier may be transmitted. For example, the product identifier may be transmitted to a server, such as the server 102. By transmitting the product identifier to a remote computer, the mobile terminal may gain access to product information, promotional information, and merchant information relating to the product as stored on the server 202.

At action 406, the method 400 may receive information associated with the product identifier. For example, if the scanned product is found in the data base, the application may be provided with product summary data, a price comparison of the product at nearby merchants or at e-commerce sites, or a list of available promotions associated with the product may be provided. If the scanned product is not found, information may be received indicating at such. For example, a message indicating “no products found” may be received if no product is associated with the product identifier in the product datastore accessed by the server 202.

At action 408, the method 400 displays the item information received at action 406. For example, the application may display all nearby retailer stores based on the current latitude and longitude value or a location associated with the device (if the application has access to device location information). Real time online store information may also be displayed for e-commerce sites that have the product. In some embodiments, reviews for the product or a product information page may also be displayed. The user may also be prompted to select from one or more coupons or rebates available for the product.

FIG. 5 depicts a flow diagram of a method 500 for identifying and transmitting product information in accordance with some example embodiments. The method 500 is operable to identify information about a product or service based on a product identifier. The information about the product or service may be transmitted to a mobile terminal for display to a user to assist in making a purchase decision about the product or service.

At action 502, the method 500 receives an identifier for a product or service. As described with respect to the method 400, the product identifier may be a UPC, data retrieved from a QR code, or the like. The method 500 may be operable to validate the received product identifier to ensure that the product identifier is associated with data that may be used to provide a user with product information. For example, a lookup operation may be performed using the product identifier as a key to obtain information about the product inventory level, whether the product is associated with any promotions, and whether the supplier of the product has provided any product data.

At action 504, the method 500 determines inventory levels of the product or service. The method 500 may be operable to determine inventory for one or more merchants, including merchants with physical locations and e-commerce merchants. The method 500 may be aware of the location of the mobile terminal, and query one or more merchants within physical proximity to the mobile terminal. The method 500 may also be aware of a zip code or residence location of the customer, and may provide inventory information for locations proximate to the zip code or residence location.

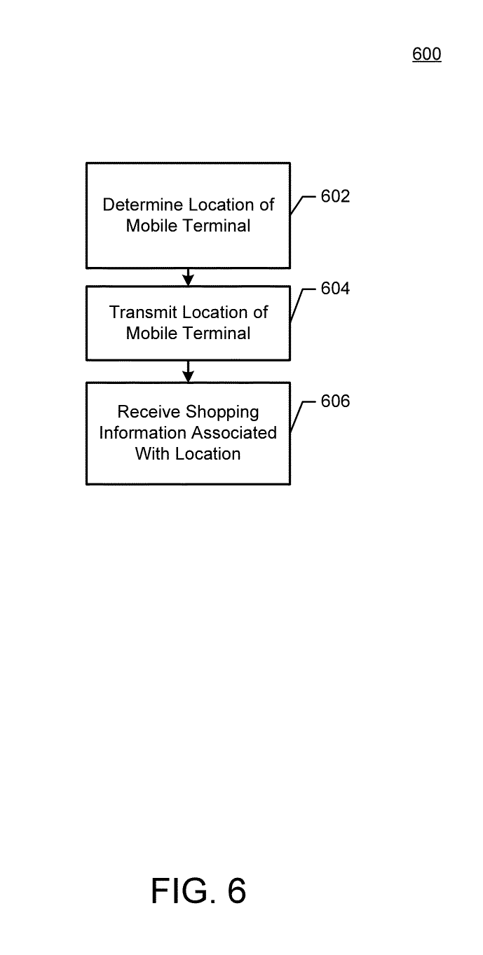

FIG. 6 depicts a flow diagram of a method 600 for receiving shopping information based on a location in accordance with some example embodiments. The method 600 is operable to provide a mobile terminal with information to assist the user of the mobile terminal with shopping by using the location of the mobile terminal to identify stores and deals that are offered proximate to the location of the mobile terminal. The mobile terminal may send a location to a server, and receive a set of shopping information based on the location. The shopping information may include marketing information, special offers, information about nearby merchants, and the like.

At action 602, the mobile terminal may determine a location. The location may be based on a current location of the mobile terminal (e.g., by using a GPS receiver or other location-based service sensor coupled to the mobile terminal), based on a location associated with a user login or other user credential (e.g., a home address of the user), or based on a manually input location (e.g., a zip code or street address provided by the user). At action 604, the determined location may be transmitted to a server, such as the server 202 described with respect to FIG. 2.

At action 604, the mobile terminal may receive shopping information based on the location. As described above, shopping information may include coupons, promotional information, advertisements, store information, or the like for merchants nearby to the provided location. The mobile terminal may also receive requests from merchants or suppliers based on a location. For example, a merchant or supplier may wish to conduct market research for a demographic associated with a particular area, and request that the user complete a survey or gather data in exchange for compensation.

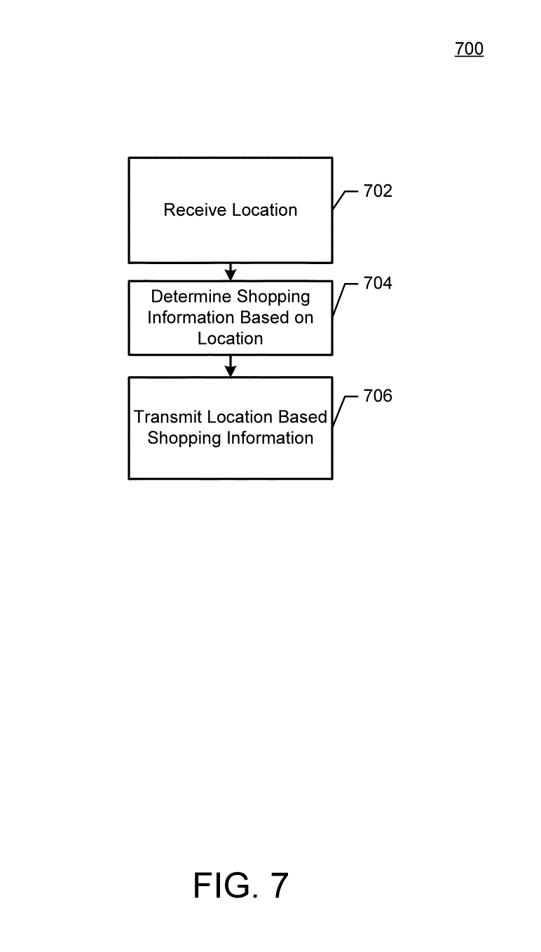

FIG. 7 depicts a flow diagram of a method 700 for providing location-based shopping information in accordance with some example embodiments. The method 700 is operable to determine shopping information for transmission to a user based upon receiving a location associated with the user. The method 700 may correspond to “server-side” processing of the method 600 as described above with respect to FIG. 6.

At action 702, the method 700 receives a location. As described above with respect to FIG. 6, the location may be a current location of the customer device, a location associated with a user account, or a location manually entered by a user. Alternatively, the location may be associated with an internal data structure with stored location data. For example, information may be provided to a user in response to a new deal becoming available in the user's area, or at a merchant at which the user previously purchased a product or service.

At action 704, shopping information is determined based on the location. As described above, shopping information may include information about products, promotions, services, merchants, or suppliers that is relevant to the received location. At action 706, the determined shopping information is transmitted to the customer device.

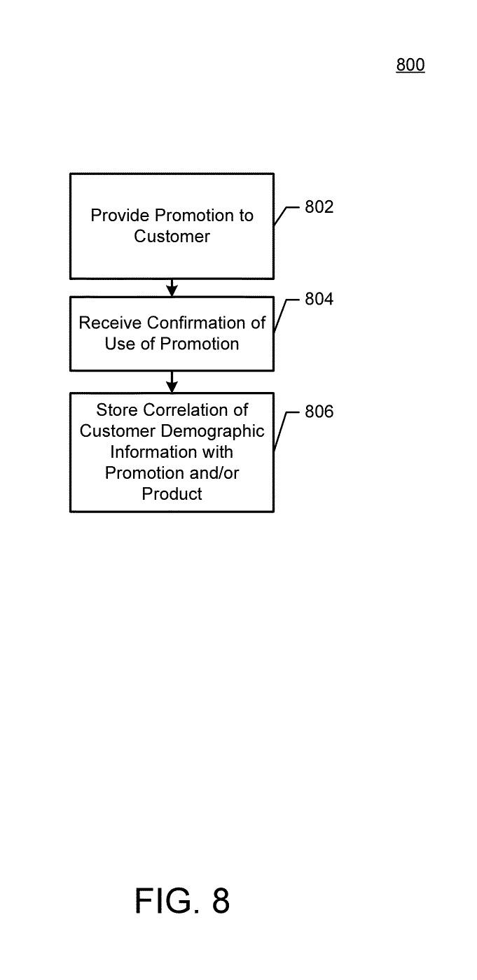

FIG. 8 depicts a flow diagram of a method 800 for capturing user shopping information in accordance with some example embodiments. In addition to providing users of the system with real-time, accurate, targeted shopping information, the system may also receive data shared by users in order to improve the user shopping experience. For example, the system may receive confirmation when a user redeems a coupon or purchases an item associated with a promotion provided to the user by the system. The system may use this data to identify trends and other analytics regarding user purchase and spend patterns. Information is preferably aggregated and obfuscated such that individual user information is not exposed to third parties. Users may be provided with an interface to “opt in” to data gathering and sharing. In some embodiments, users may have multiple levels of sharing rights, such that they can provide retailers or manufacturers as much or as little information as the user desires. In some embodiments, retailers and manufacturers may provide the user with certain benefits in exchange for sharing their information. Typically, the more information the user chooses to share with the system, the more effective the system will be at improving the user's shopping experience.

At action 802, information about a particular product or promotion is provided to a customer. The information may include details about a sale or “hot deal” associated with the product, or the information may include a coupon for the product, or a rebate deal for the product. The information may be provided to customers that previously expressed an interest in the product, service, or a location at which the promotion is being provided. For example, a user may have previously scanned or searched for the same product or a similar product, or the product may be present on a shopping list or wish list maintained by the user. In some embodiments, the information may be associated with a particular merchant or store location, and the promotion may be offered to users that previously purchased products at that location. In yet further embodiments, the product or promotional information may be provided to users in a particular demographic, such as users in a particular age group or users who are proximate to a particular location (e.g., users in a particular zip code). The information may include an identifier to link the promotion offer to a particular customer or customer device (e.g., a one-time use coupon code).

At action 804, the method 800 receives confirmation that the user has taken advantage of the information by purchasing the product or using the coupon or promotion. The method 800 may receive this confirmation by integration with a merchant's point-of-sale system (e.g. upon scanning a coupon code) or by receiving a transmission from the customer device. In some embodiments, the promotion is provided via a rebate system, and the confirmation of the rebate may be provided by a supplier rebate redemption system or other validation of the rebate application.

At action 806, the method 800 stores data indicating that the promotion, coupon, rebate, or the like was redeemed by the customer. In some embodiments, the redemption may be associated with the particular customer, and customer demographic data may be stored to gauge the success of the promotion campaign, coupon, rebate, or the like. For example, such data may be used to indicate the percentage of customers that received the offer than redeemed the offer.

FIG. 9 depicts a screen capture of a “dashboard” interface 900 allowing merchants and suppliers to interface with the system via a server-side or back end interface. For example, the server 202 may provide a web interface to allow a supplier device 212 or a merchant device 214 to add, edit, modify, or delete product information, promotional information, store information, or the like. The interface 900 may also provide access to sale analytics, such as location and/or demographic information for item sales. In this manner, the system may provide efficient, direct access to sale and marketing information and analytics, and allow merchants and suppliers to directly manage product information and generation and hosting of deals, promotions, coupons, and the like.

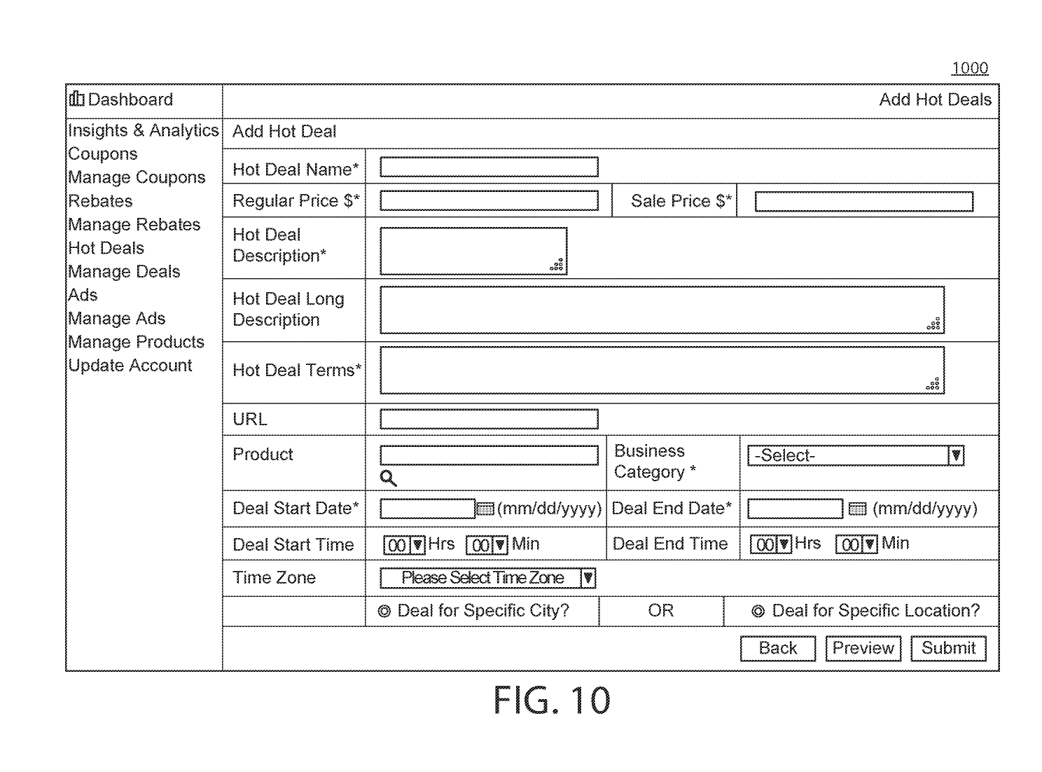

FIG. 10 depicts a screen capture of an interface 1000 for generating deal information in accordance with some example embodiments. The interface 1000 allows for a user of a back-end application, such as a web interface provided by the server 202 and accessed by a merchant device 214, to add a promotion or “hot deal” for a particular item. The interface allows the user to input price information, item information, a description of the deal, terms and conditions for the deal, a duration or dates for the deal, a website address for the deal, and the like. The deal may be tied to a particular location or locations, or the deal may be active at all locations for the particular merchant. Deal information captured in this manner may be stored as merchant data, such as the merchant datastore 206. The deal information may also be linked to a particular product stored in a product datastore 208.

FIG. 10 depicts a screen capture of an interface 1100 for generating rebate information in accordance with some example embodiments. Although “hot deals” and other promotional prices may typically be associated with merchants, rebate deals may be offered by either merchants or suppliers, or by the two in combination. As such, rebate deals may be valid at any merchant or at multiple merchants. These rebates may also require the customer to perform a certain action to redeem the rebate. For example, the customer may need to provide a product label or UPC code from product packaging to receive the rebate. The interface 1100 depicts a back-end system, such as provided for a merchant device 214 or a supplier device 212 by a server 202, for creating rebates to be sent to users of the system. As with the interface 1000, the interface 1000 may provide a fillable form for entering information to generate or edit rebate information. The rebate may be limited in quantity, location, or time, and the user may supply such information via the form. The rebate may also be associated with a particular product or products.

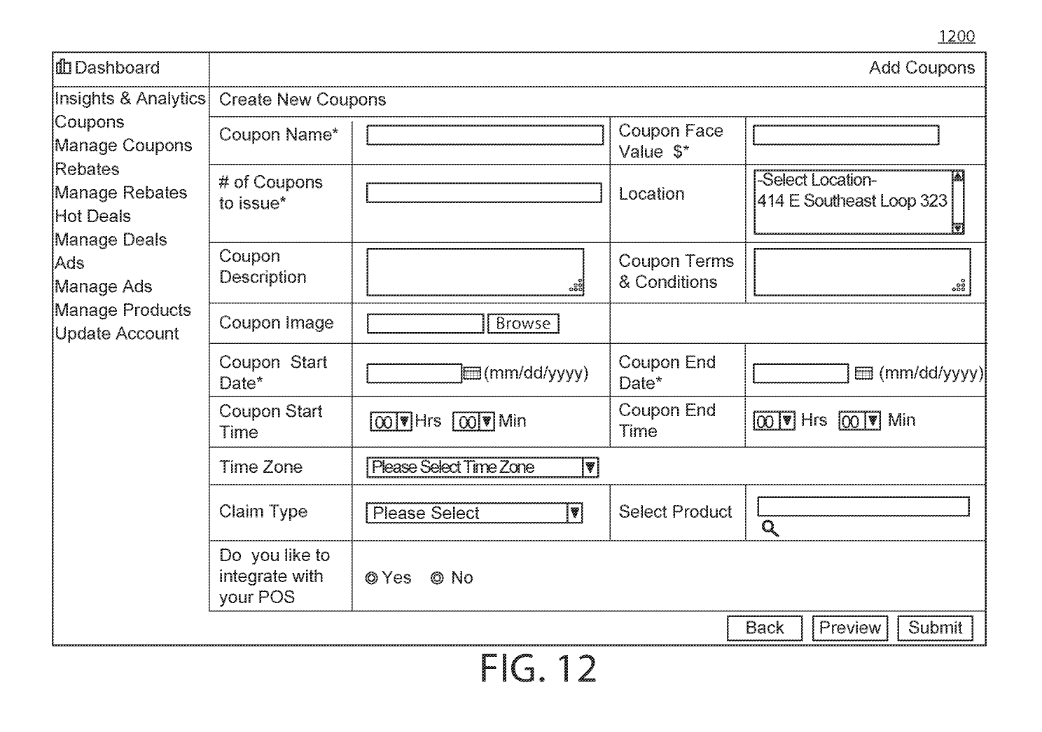

FIG. 12 depicts a screen capture of an interface 1200 for generating a coupon in accordance with some example embodiments. As with the deal and rebate generation interfaces, the interface 1200 provides a back-end, web-accessible interface for allowing merchants and suppliers to create coupons, which may then be provided to customer devices for redemption. The interface 1200 allows for definition of coupons based on product type, merchant location, quantity, time period, and the like. As described above with respect to FIG. 8, coupons may be associated with particular users or customer devices, such that use of the coupon may be monitored by the system. As described above, the system may interface with a point-of-sale system for validation and confirmation of coupons generated by the interface 1200.

Each of the interfaces 900, 1000, 1100, 1299 may be accessible via login credentials provided to the merchant to ensure that the user is authorized to generate the respective deals, rebates, and coupons. Merchants and suppliers may register with the server 202 and be validated to receive such login credentials. In some embodiments, merchants and/or retailers may be charged a fee for use of the service. The fee may be determined based on a flat rate, based on the number of locations of the merchant, the sales volume of the supplier, the number of rebates, promotions, and or deals created by the merchant or supplier, the number of products associated with the merchant or supplier, or any other metric for calculation of a fee. In some embodiments, the system may include a mechanism for donating to one or more charitable causes using revenue generated by such fees.

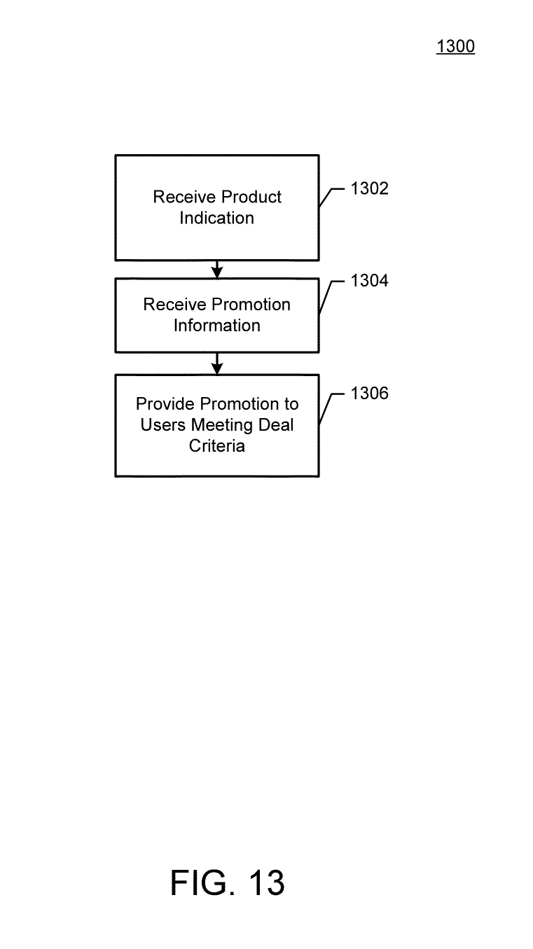

FIG. 13 depicts a flow diagram of a method 1300 for providing promotions to customers in accordance with some example embodiments. As described above, deals, coupons, and rebates generated by the system may be provided to users of the system, such as via the customer device 210 associated with the particular user. In this manner, merchants and suppliers may ensure that customers are made aware of products, services, and promotions. Particular customers may be identified for reception of this information based on customer demographic information, customer purchase histories, or the like. The method 1300 describes a process for identification of customers and providing information to the identified customers. The example method 1300 describes a process by which customers are identified via their decision to scan a particular item. In other embodiments, other factors can be employed to identify customers, such as through identifying items within a customer wish list, user preferences, user locations, previously purchased products by the user, reviews the user has created, or other user demographic information.

At action 1302, an indication of a particular product is received. The product indication may be provided by the customer (e.g., by scanning a product identifier, searching for the product, adding the product to a shopping list, or the like). At action 1304, promotions may be identified that are associated with the particular product. These promotions may include coupons, rebates, deals, competitor products, or any other marketing information that may be derived based on the customer's indication of interest in the particular product. At action 1306, the promotional information is sent to the customer device for the customer's review.

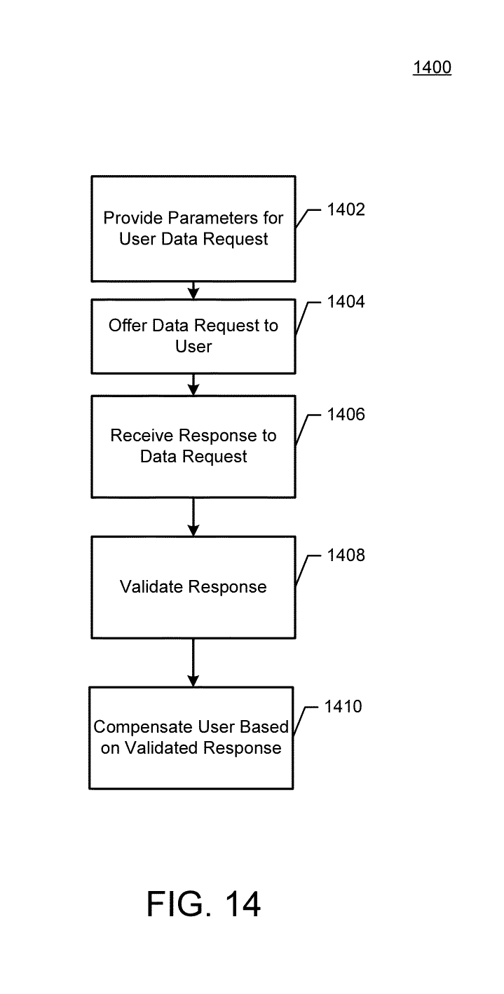

FIG. 14 depicts a flow diagram for a method 1400 for providing data requests to customers in accordance with some example embodiments. In addition to information about products and services, the system also allows for a direct line of access from customers to merchants or suppliers. In this manner, the merchants or suppliers may also request data from customers. For example, a merchant may be curious as to customer preferences among a particular set of products or brand names, and provide the customer with a survey to obtain such data. A supplier may be interested to know about which competitor brands are stocked by a particular merchant, or what customers who have previously purchased their product think of their experience. These data requests may include compensation for the customer if the customer provides a response. For example, the merchant or supplier may provide the customer with a special coupon or discount code, or the customer may receive a store credit, gift card, or cash payment for providing answers to data requests. As with the promotional information described above, deal requests may also be provided to customers that meet particular location or demographic criteria, or based on the customer's previous purchase history. For example, a supplier may be interested to know what women between the ages of 30 and 40 who have two or more children think about their product. In this manner, the system provides a flexible, direct channel for merchants and suppliers to gain market research while also providing a benefit to customers.

At action 1402, the merchant or supplier provides parameters for the data request. For example, the merchant or supplier may provide a set of questions for the customer to answer, along with a particular customer demographic, location, or the like. The merchant or supplier may also specify a reward for completion of the data request, such as a coupon, rebate, gift card, or cash reward.

At action 1404, the data request may be offered to customers. A list of available data gathering requests may be available to customers via customer devices. For example, an interface option may list all data gathering requests for which the customer qualifies (e.g., based on location and demographic information, or based on product purchase histories).

At action 1406, a response to the data request is provided by the customer. The response may include answers to the questions posed by the merchant or supplier when generating the data request.

At action 1408, the response may be validated. For example, processing may be performed to determine if the customer filled out all fields of the response, and that the fields contain valid data. Responses may be manually curated, such as by a moderator. After validation of the response, the customer may be provided with the designated reward at action 1410.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving, a first set of information relating to one or more products, from a supplier of the product;
receiving, from a merchant, a second set of information relating to at least one of the one or more products;
determining, using a processor, eligibility of a customer for the one or more promotions based on a set of criteria associated with the one or more promotions and a set of customer information; and
in response to determining that the customer is eligible for the one or more promotions, providing a notification to a customer device associated with the customer of the one or more promotions.

2. The method of claim 1, further comprising receiving a location associated with the customer, wherein the location is part of the set of customer information and the location is one of the criteria associated with the one or more promotions.

3. The method of claim 1, wherein the one or more promotions are associated with a particular store location of the retailer chosen from a plurality of store locations of the retailer.

4. The method of claim 1, wherein the promotion is at least one of a coupon, a rebate, or a discounted price.

5. The method of claim 1, further comprising:
receiving information indicating the user has used the one or more promotions; and
capturing analytics data indicating the user has used the one or more promotions.

6. The method of claim 1, further comprising:
receiving data from a point-of-sale indicating the customer wishes to use the one or more promotions in a transaction; and
validating the one or more promotions to the point-of-sale such that the one or more promotions are applied to the transaction.

7. The method of claim 1, further comprising:
receiving information about a plurality of products from a customer device;
associating the plurality of products with the customer device; and
providing the customer device with one or more promotions for at least one of the plurality of products.

8. A computer program product comprising at least one non-transitory computer-readable storage medium bearing computer program instructions embodied therein for use with a computer, the computer program instructions comprising program instructions configured to:
receive a first set of information, the first set of information relating to one or more products from a supplier of the product;
receive, from a merchant, a second set of information, the second set of information relating to one or more promotions relating to at least one of the one or more products;
determine eligibility of a customer for the one or more promotions based on a set of criteria associated with the one or more promotions and a set of customer information; and
in response to determining that the customer is eligible for the one or more promotions, provide a notification to a customer device associated with the customer of the one or more promotions.

9. The computer program product of claim 8, wherein the program instructions are further configured to receive a location associated with the customer, wherein the location is part of the set of customer information and the location is one of the criteria associated with the one or more promotions.

10. The computer program product of claim 8, wherein the one or more promotions are associated with a particular store location of the retailer chosen from a plurality of store locations of the retailer.

11. The computer program product of claim 8, wherein the promotion is at least one of a coupon, a rebate, or a discounted price.

12. The computer program product of claim 8, wherein the program instructions are further configured to:
receive information indicating the user has used the one or more promotions; and
capture analytics data indicating the user has used the one or more promotions.

13. The computer program product of claim 8, wherein the program instructions are further configured to:
receive data from a point-of-sale indicating the customer wishes to use the one or more promotions in a transaction; and
validate the one or more promotions to the point-of-sale such that the one or more promotions are applied to the transaction.

14. The computer program product of claim 8, wherein the program instructions are further configured to:
receive a plurality of products from a customer device;
associate the plurality of products with the customer device; and
provide the customer device with one or more promotions for at least one of the plurality of products.

15. An apparatus comprising at least one processor and at least one memory including computer program instructions, the at least one memory and the computer program instructions configured to, with the at least one processor, cause the apparatus at least to:
receive a first set of information relating to one or more products from a supplier of the product;
receive, from a merchant, a second set of information relating to one or more promotions, the one or more promotions relating to at least one of the one or more products;
determine eligibility of a customer for the one or more promotions based on a set of criteria associated with the one or more promotions and a set of customer information; and
in response to determining that the customer is eligible for the one or more promotions, provide a notification to a customer device associated with the customer of the one or more promotions.

16. The apparatus of claim 15, wherein the apparatus is further configured to receive a location associated with the customer, wherein the location is part of the set of customer information and the location is one of the criteria associated with the one or more promotions.

17. The apparatus of claim 15, wherein the one or more promotions are associated with a particular store location of the retailer chosen from a plurality of store locations of the retailer.

18. The apparatus of claim 15, wherein the promotion is at least one of a coupon, a rebate, or a discounted price.

19. The apparatus of claim 15, wherein the apparatus is further configured to:
receive information indicating the user has used the one or more promotions; and
capture analytics data indicating the user has used the one or more promotions.

20. The apparatus of claim 15, wherein the apparatus is further configured to:
receive data from a point-of-sale indicating the customer wishes to use the one or more promotions in a transaction; and
validate the one or more promotions to the point-of-sale such that the one or more promotions are applied to the transaction.

21. The apparatus of claim 15, wherein the apparatus is further configured to:
receive a plurality of products from a customer device;
associate the plurality of products with the customer device; and
provide the customer device with one or more promotions for at least one of the plurality of products.
